(19) United States
(12) Patent Application Publication
(10) Pub. No.: US 2009/0135970 A1
(43) Pub. Date: May 28, 2009

(54) DIRECT CONVERSION RECEIVER

(75) Inventors: Hiroshi Miyagi, Tokyo (JP); Yukio Koyanagi, Tokyo (JP)

Correspondence Address: PATENTTM.US, P. O. BOX 82788, PORTLAND, OR, 97282-0788, US

(73) Assignee: NEURO SOLUTION CORP., Tokyo (JP)

(21) Appl. No.: 12/063,230

(22) PCT Filed: Aug. 9, 2006
(86) PCT No.: PCT/JP2006/315728

§ 371 Date: Feb. 7, 2008

(30) Foreign Application Priority Data
Aug. 12, 2005 (JP) 2005-234755
Aug. 12, 2005 (JP) 2005-234758

(51) Int. Cl. H04L 27/08

(52) U.S. Cl. 375/345

(57) ABSTRACT

A direct conversion receiver wherein even when signals are continuously received, the automatic gain control can be implemented in accordance with the signal levels from which DC offset voltages have been removed. The direct conversion receiver comprises a low-noise amplifier 14, a mixer 16, a local oscillator (LO) 20, a lowpass filter (LPF) 23, a baseband amplifier (second amplifier) 24, an analog-to-digital converter (ADC) 26, digital-to-analog converters (DAC) 28, 32, a signal processing section 30, a speaker 34, a DC component extracting filter 100, an average value calculating circuit 200 and a subtractor 210. The average value calculating circuit 200 calculates an average value of the signal levels of the baseband signals. The DC offset voltage extracted by the DC component filter 100 is subtracted from the average value, thereby generating a control voltage, which then controls the gain of the input circuit 10 or low-noise amplifier 14.

### TECHNICAL FIELD

The present invention relates to a direct conversion receiver which converts a received signal to a base band signal and executes demodulating process, or the like.

### BACKGROUND ART

A direct conversion receiver mixes a received high frequency signal with a local oscillation signal which has the same frequency as the high frequency signal by a mixer to generate a base band signal. In the mixer, the local oscillation signal leaking into a terminal into which the high frequency signal is input causes an output signal to include a direct current (DC) offset voltage, degrading a reception sensitivity. For this reason, a receiver has been known up to now which removes the DC offset voltage using a guard interval (refer to Patent Document 1, for example).
Patent Document 1: Japanese Patent Laid-Open No. 2001-245006, pp. 5 to 11, FIGS. 1 to 10.

The DC offset voltage is removed using a guard interval as disclosed in the above Patent Document 1, which cannot be applied to such an AM receiver that continuously receives signals, causing a problem that cannot perform automatic gain control (AGC) according to a correct signal level from which DC offset voltage has been removed.

The present invention has been made in view of the above respects and has as its object to provide a direct conversion receiver capable of performing the automatic gain control according to a signal level from which DC offset voltage has been removed even if the receiver continuously receives signals.

Another object of the present invention is to provide a direct conversion receiver capable of removing the direct current offset voltage even if the receiver continuously receives signals.

### DISCLOSURE OF THE INVENTION

To solve the above problems, the direct conversion receiver of the present invention includes: a first amplifier to which a signal received through an antenna is input and which amplifies the signal with a gain according to a control voltage; a local oscillator which generates a local oscillation signal having the same frequency as a signal desired to be received; a mixer which mixes the signal amplified by the first amplifier with the local oscillation signal to generate a baseband signal; a second amplifier which amplifies the baseband signal output from the mixer; an analog-to-digital converter which converts the signal amplified by the second amplifier to digital data; a first DC component extracting filter which extracts a DC component as a DC offset voltage included in the baseband signal based on the data output from the analog-to-digital converter; an average value calculating circuit which calculates the average value of the data output from the analog-to-digital converter; a first subtractor which subtracts the DC component extracted by the first DC component extracting filter from the average value calculated by the average value calculating circuit; and a first digital-to-analog converter which converts the data subjected to subtraction in the first subtractor to the control voltage of analog; wherein the first DC component extracting filter includes an accumulating unit which accumulates the value of the predetermined number N of input data and a coefficient multiplying unit which multiplies the value accumulated by the accumulating unit by a coefficient of 1/N or a coefficient which is one (1) or less and larger than 1/N.

Furthermore, the direct conversion receiver of the present invention includes: a first amplifier which amplifies a signal received through an antenna; an input circuit which is provided between the antenna and the first amplifier and has a gain corresponding to a control voltage; a local oscillator which generates a local oscillation signal having the same frequency as a signal desired to be received; a mixer which mixes the signal amplified by the first amplifier with the local oscillation signal to generate a baseband signal; a second amplifier which amplifies the baseband signal output from the mixer; an analog-to-digital converter which converts the signal amplified by the second amplifier to digital data; a first DC component extracting filter which extracts a DC component as a DC offset voltage included in the baseband signal based on the data output from the analog-to-digital converter; an average value calculating circuit which calculates the average value of the data output from the analog-to-digital converter; a first subtractor which subtracts the DC component extracted by the first DC component extracting filter from the average value calculated by the average value calculating circuit; and a first digital-to-analog converter which converts the data subjected to subtraction in the first subtractor to the control voltage of analog; wherein the first DC component extracting filter includes an accumulating unit which accumulates the value of the predetermined number N of input data and a coefficient multiplying unit which multiplies the value accumulated by the accumulating unit by a coefficient of 1/N or a coefficient which is one (1) or less and larger than 1/N.

The direct conversion receiver of the present invention includes: a first amplifier to which a signal received through an antenna is input and which amplifies the signal with a gain according to a control voltage; a local oscillator which generates a local oscillation signal having the same frequency as a signal desired to be received; a mixer which mixes the signal amplified by the first amplifier with the local oscillation signal to generate a baseband signal; a second amplifier which amplifies the baseband signal output from the mixer; an analog-to-digital converter which converts the signal amplified by the second amplifier to digital data; a first and a second DC component extracting filters which extract a DC component as a DC offset voltage included in the baseband signal based on the data output from the analog-to-digital converter; an average value calculating circuit which calculates the average value of the data output from the analog-to-digital converter; a first subtractor which subtracts the DC component extracted by the first DC component extracting filter from the average value calculated by the average value calculating circuit; a first digital-to-analog converter which converts the data subjected to subtraction in the first subtractor to the control voltage of analog; a second digital-to-analog converter which converts the data corresponding to a DC component extracted by the second DC component extracting filter to an analog voltage; and a second subtractor which subtracts the output voltage of the second digital-to-analog converter from the baseband signal output from the mixer to remove the DC offset voltage included in the baseband signal; wherein the first and the second DC component extracting filters include an accumulating unit which accumulates the value of the predetermined number N of input data and a coefficient multiplying unit which multiplies the value accumulated by the accumulating unit by a coefficient of 1/N or a coefficient which is one (1) or less and larger than 1/N.

The direct conversion receiver of the present invention includes: a first amplifier which amplifies a signal received through an antenna; an input circuit which is provided between the antenna and the first amplifier and has a gain corresponding to a control voltage; a local oscillator which generates a local oscillation signal having the same frequency as a signal desired to be received; a mixer which mixes the signal amplified by the first amplifier with the local oscillation signal to generate a baseband signal; a second amplifier which amplifies the baseband signal output from the mixer; an analog-to-digital converter which converts the signal amplified by the second amplifier to digital data; a first and a second DC component extracting filters which extract a DC component as a DC offset voltage included in the baseband signal based on the data output from the analog-to-digital converter; an average value calculating circuit which calculates the average value of the data output from the analog-to-digital converter; a first subtractor which subtracts the DC component extracted by the first DC component extracting filter from the average value calculated by the average value calculating circuit; a first digital-to-analog converter which converts the data subjected to subtraction in the first subtractor to the control voltage of analog; a second digital-to-analog converter which converts the data corresponding to a DC component extracted by the second DC component extracting filter to an analog voltage; and a second subtractor which subtracts the output voltage of the second digital-to-analog converter from the baseband signal output from the mixer to remove the DC offset voltage included in the baseband signal; wherein the first and the second DC component extracting filters include an accumulating unit which accumulates the value of the predetermined number N of input data and a coefficient multiplying unit which multiplies the value accumulated by the accumulating unit by a coefficient of 1/N or a coefficient which is one (1) or less and larger than 1/N.

The first and the second DC component extracting filters calculate the moving average of the input data to enable lower frequency components (or DC components) included in the input data to be extracted. Furthermore, multiplying units of the number of which corresponds to the number of objects subjected to the calculation of the moving average are not required, which allows circuit scale to be reduced and processing contents to be simplified. In particular, accumulating N input data and then multiplying the accumulated N data by a coefficient of 1/N prevent a rounding error caused by an accumulating process from being produced at the time of calculating the moving average and inhibits decrease in calculation accuracy. Setting the coefficient to one (1) or less and a value larger than 1/N enables DC components to be extracted and data to be amplified. Furthermore, if amplification is performed in a circuit or the like, at the rear stage, amplification is performed after lower bit information has lacked, however in the present invention, data can be taken out before lower bit information lacks, so that S/N ratio and dynamic range can be improved. The DC offset voltage included in the baseband signal is extracted by such a first DC component extracting filter and subtracted from the average value of the baseband signal, thereby enabling correctly detecting the signal level of the carrier to allow the automatic gain control for continuously received signals. Using the second DC component extracting filter permits extracting the DC offset voltages included in the baseband signal corresponding to continuously received signals and removing them.

The foregoing accumulating unit desirably includes: a delay unit which holds the (N+1) input data in the order of input and outputs them; a first adding unit which adds an accumulated value to the input data; a data holding unit which holds a result of addition by the first adding unit for a time period corresponding to a time interval of the data is input; and a second adding unit which outputs a result of subtracting the output data of the delay unit from the data output from the data holding unit both to the first adding unit and to the coefficient multiplying unit as the accumulated value. This enables a new input data to be added to the accumulated value every time data is input and the earliest input data to be subtracted from the accumulated value to renew the accumulated value, permitting a moving average to be calculated with a simple circuit configuration and a few processing steps.

The output of any of the first adding unit and the data holding unit is desirably input to the coefficient multiplying unit. The results of this process are those of accumulation themselves or equivalent to the results of accumulation, providing an output (or a moving average value) in which the input data is amplified with a predetermined gain.

The aforementioned delay unit is desirably formed of a semiconductor memory. This allows a large-scale delay unit to be easily realized.

It is desirable that the above coefficient of the coefficient multiplying unit is represented by ½^{m}, where, “m” is an integer of one (1) or more, and the coefficient multiplying unit shifts bit position to perform multiplication with ½^{m} as a coefficient. If N=2^{m}, a multiplication of a coefficient 1/N=½^{m} can be performed by shifting a bit position to lower side by “m” bits, and furthermore, if the coefficient is fixed, the multiplication can be realizing by more simply arranging wiring to shift a bit position from which data is taken out to the upper side by “m” bits, thereby allowing forming the DC component extracting filter without practically using a coefficient multiplying unit.

### BRIEF DESCRIPTION OF THE DRAWINGS

FIG. 1 is a block diagram illustrating the basic configuration of a direct conversion receiver of a first embodiment;

FIG. 2 is a block diagram illustrating a detailed configuration of a DC component extracting filter;

FIG. 3 is a graph illustrating a result of simulating the frequency characteristic of the DC component extracting filter;

FIG. 4 is an example of a modification of the direct conversion receiver illustrated in FIG. 1;

FIG. 5 is another example of a modification of the direct conversion receiver illustrated in FIG. 1;

FIG. 6 is a block diagram illustrating the configuration of a frequency component separation filter;

FIG. 7 is a graph illustrating a result of simulating the frequency characteristic of the frequency component separation filter;

FIG. 8 is a block diagram illustrating the basic configuration of a direct conversion receiver of a second embodiment;

FIG. 9 is an example of a modification of the direct conversion receiver illustrated in FIG. 8;

FIG. 10 is a block diagram illustrating the configuration of the direct conversion receiver of a third embodiment in which an orthogonal modulation function is added to the configuration in FIG. 1; and

FIG. 11 is a block diagram illustrating the configuration of a direct conversion receiver in which an orthogonal modulation function is added to the configuration in FIG. 8.

### DESCRIPTION OF SYMBOLS

10 Input circuit
14 Low-noise amplifier (LNA)
16 Mixer
20 Local oscillator (LO)
23 Lowpass filter (LPF)
24 Baseband amplifier
26 Analog-to-digital converter (ADC)
28 & 32 Digital-to-analog converters (DAC)
30 Signal processing section
34 Speaker
100 DC component extracting filter
100A Frequency component separation filter
110 Delay circuit
120, 122 & 124 Adders
130 D type flip flop
132 Coefficient multiplier
200 Average value calculating circuit

### BEST MODE FOR CARRYING OUT THE INVENTION

The direct conversion receiver of a first embodiment to which the present invention is applied is described in detail below.

### First Embodiment

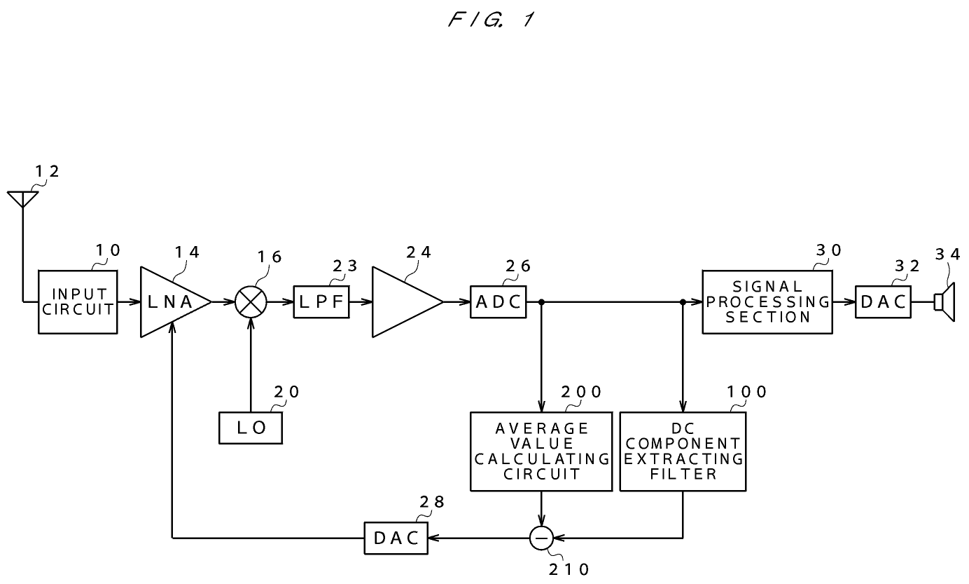

FIG. 1 is a block diagram illustrating the basic configuration of a direct conversion receiver of a first embodiment. As illustrated in FIG. 1, the direct conversion receiver of the present embodiment includes an input circuit 10, a low-noise amplifier (LNA, a first amplifier) 14, a mixer 16, a local oscillator (LO) 20, a lowpass filter (LPF) 23, a baseband amplifier (a second amplifier) 24, an analog-to-digital converter (ADC) 26, digital-to-analog converters (DAC) 28 and 32, a signal processing section 30, a speaker 34, a DC component extracting filter 100, an average value calculating circuit 200 and a subtractor 210. The above DC component extracting filter 100, the subtractor 210 and the digital-to-analog converter 28 correspond to a first DC component extracting filter, a first subtractor and a first digital-to-analog converter, respectively.

Although the receiver serves to receive such a continuously delivered signal as an AM broadcasting wave or a FM broadcasting wave, the present invention may also be applied to a receiver which intermittently receives a signal. Most of the components used for the direct conversion receiver are integrally formed on a semiconductor substrate using MOS process or CMOS process, except an antenna 12, the speaker 34 and a small number of other components such as, for example, a signal processing section 30, the DC component extracting filter 100, a quartz oscillator required for generating operation clocks for the average value calculating circuit 200. The signal processing section 30, the DC component extracting filter 100 and the average value calculating circuit 200 may be realized by using, for example, a digital signal processor (DSP).

The input circuit 10 serves to match impedances between the antenna 12 and the low-noise amplifier 14 and includes a tuning circuit for selecting a broadcast wave desired to be received or a bandpass filter. The low-noise amplifier 14 amplifies a received signal input through the input circuit 10. The amplification factor (gain) of the low-noise amplifier 14 is set according to a control voltage which is input from the digital-to-analog converter 28. The mixer 16 mixes the received signal amplified by the low-noise amplifier 14 with a local oscillation signal output from the local oscillator 20 to output a baseband signal. The local oscillator 20 outputs the local oscillation signal having same frequency as the broadcast wave desired to be received.

The lowpass filter 23 eliminates frequency components higher than the frequency components in the required band included in the baseband signal output from the mixer 16. When AM broadcast waves are received, for example, frequency components higher than the frequencies of a voice band are eliminated. The baseband amplifier 24 amplifies the baseband signal input thereto through the lowpass filter 23. The analog-to-digital converter 26 samples the amplified baseband signal output from the baseband amplifier 24 with a predetermined frequency to convert it to digital data. The sampling frequency is set to a frequency twice as high as the required band. When AM broadcast waves are received, for example, a sampling frequency of 50 kHz which is twice or more as high as the upper limit of the voice band is used.

The signal processing section 30 subjects the baseband signal converted to digital data to a signal processing such as demodulation to generate voice data. The digital-to-analog converter 32 converts the audio data output from the signal processing section 30 to an analog audio signal to output it through the speaker 34.

The DC component extracting filter 100 extracts a DC offset voltage being a direct current (DC) component included in the baseband signal based on the digital data output from the analog-to-digital converter 26. For example, frequency components of 10 Hz or lower are extracted. The average value calculating circuit 200 calculates the average value of level of the baseband signal based on the digital data output from the analog-to-digital converter 26. The subtractor 210 subtracts the DC offset voltage extracted by the DC component extracting filter 100 from the average value calculated by the average value calculating circuit 200. The average value of level of the baseband signal varies with the level (amplitude) of a carrier included in a received signal. If the DC offset voltage is included in the baseband signal, the average value also includes components corresponding to the DC offset voltage. Removing the components corresponding to the DC offset voltage with using the subtractor 210 enables the signal level of the carrier to be correctly obtained.

The direct conversion receiver of the present embodiment has such a configuration. The operation of automatic gain control according to the level of a received signal is described below. The baseband signal output from the baseband amplifier 24 includes DC components generated by the local oscillation signal leaking into the input side of the received signal in the mixer 16 and DC components as an offset voltage generated in the baseband amplifier 24. The DC component extracting filter 100 extracts these DC components of 10 Hz or lower and outputs data corresponding to the voltage level of the DC components. The average value calculating circuit 200 calculates the average value of the baseband signal including the components corresponding to the DC offset voltage and outputs data corresponding to the average value. The subtractor 210 subtracts the components corresponding to the DC offset voltage from the average value of the baseband signal and outputs data corresponding to the signal level of the carrier. The data is converted to a control voltage by the digital-to-analog converter 28 and input to the low-noise amplifier 14. For this reason, the low-noise amplifier 14 performs automatic gain control according to the signal level of the carrier. Thus, using the DC component extracting filter 100 capable of extracting the DC offset voltage from the baseband signal allows correctly detecting the signal level of a continuously received carrier to perform automatic gain control.

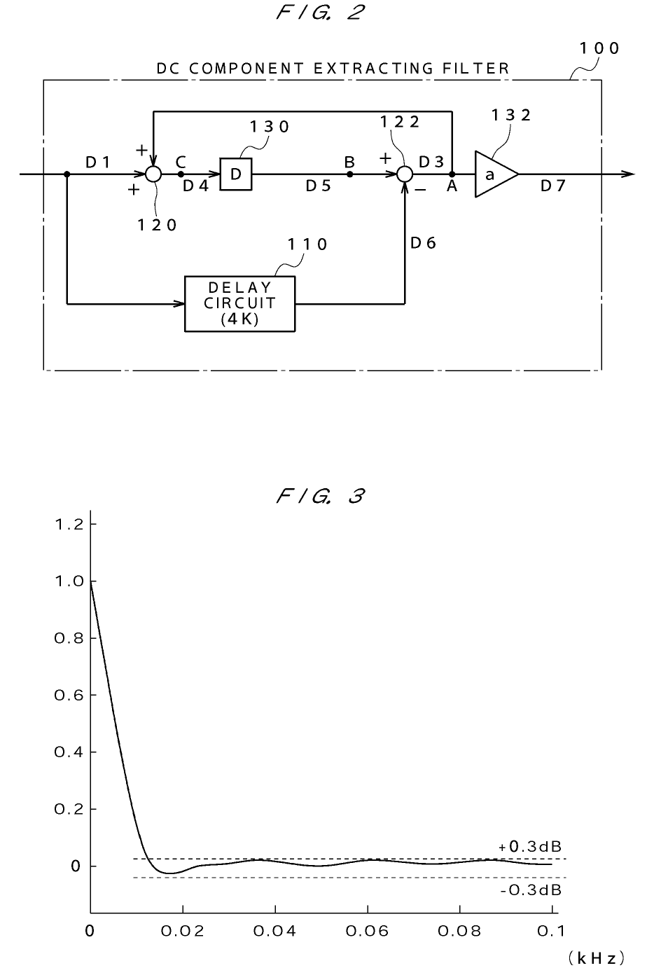

The configuration of the DC component extracting filter 100 is described in detail below. FIG. 2 is a block diagram illustrating a configuration of the DC component extracting filter 100. The DC component extracting filter 100 illustrated in FIG. 2 includes one delay circuit 110, two adders 120 and 122, one D type flip flop 130 and one coefficient multiplier 132. A 16-bit digital data sampled with a sampling frequency “f” of, for example, 50 kHz (or, digital data output from the analog-to-digital converter 26) is input to the DC component extracting filter 100.

The number of taps in the delay circuit 110 is set to 4K (=4096). The delay circuit 110 holds 4K 16-bit digital data D1 input to the DC component extracting filter 100 in the order of input and then outputs them. Since the delay circuit 110 has no intermediate taps, it may be realized by using such a semiconductor memory as a shift register or RAM.

The adder 120 adds data D1 input to the DC component extracting filter 100 to data D3 output from the adder 122 at the rear stage. The D type flip flop 130 holds data D4 as an addition result output from the adder 120 for one clock, and then outputs it. The adder 122 outputs a result in which the data D6 output from the delay circuit 110 is subtracted from data D5 held in the D type flip flop 130. The coefficient multiplier 132 whose coefficient “a” is set to 1/(4K−1)=1/4095 outputs a result as data D7 in which data D3 output from the adder 122 is multiplied by a coefficient “a.”

The delay circuit 110, the adders 120 and 122 and the D type flip flop 130 correspond to an accumulating unit and the coefficient multiplier 132 corresponds to a coefficient multiplying unit. The delay circuit 110, the adder 120, the adder 122 and the D type flip flop 130 correspond to a delay unit, a first adding unit, a second adding unit and a data holding unit, respectively.

The delay circuit 110 and the D type flip flop 130 are reset when the DC component extracting filter 100 starts its operation. For this reason, after that, when the DC component extracting filter 100 starts its operation in synchronization with an operation clock, the data D5 (=D3) held in the D type flip flop 130 is input to the adder 120 through the adder 122, added to the input data D1 and accumulated till a first (4K+1) data D1 is input.

Subsequently, when the (4K+1) th data D1 is input and an accumulated value corresponding thereto is held in the D type flip flop 130, the delay circuit 110 outputs the first data D1 in synchronization with this timing. Accordingly, the adder 122 subtracts the first data from the value accumulated so far (or the accumulated value of the 4K input data D1) and outputs an accumulated value for 4K−1 (=N) from the second input data D1 to (4K+1) th input data. Thus, after that, the accumulating process is performed in such a manner that a (4K−1) input data D1 to be accumulated is shifted one by one every time a new data D1 is input. The accumulated data D3 is multiplied by “a” (=1/(4K−1)) by a coefficient multiplier 132 and output as data D7.

The data D7 output from the coefficient multiplier 132 is such that a (4K−1) input data D1 is accumulated and then multiplied by “a” (=1/(4K−1)) to calculate a moving average, so that the (4K−1) input data D1 is smoothened, which means that lower frequency components (or DC components) of the input data D1 are extracted.

FIG. 3 is a graph illustrating a result of simulating the frequency characteristic of the DC component extracting filter 100. In FIG. 3, the abscissa and the ordinate represent frequency and amplitude value, respectively. As illustrated in FIG. 3, it was ascertained that by using the DC component extracting filter 100 of the present embodiment it can be extracted DC components less than about 20 Hz or lower and removed almost all of the frequency components higher than the above (within the range of ±0.3 dB.)

Thus, in the DC component extracting filter 100, the calculation of moving average of the input data permits extracting lower frequency components (or DC components) included in the input data. In particular, the calculation of only the moving average eliminates the need for multiplying units (or steps) of the number of which corresponds to the number of objects subjected to the calculation of the moving average like an FIR filter with a conventional configuration, enabling circuit scale to be reduced and processing contents to be simplified.

The above calculation of the moving average is realized by accumulating the predetermined number N of input data and multiplying the accumulated value by a coefficient of 1/N. This prevents a rounding error caused by an accumulating process from being produced at the time of calculating the moving average and inhibits decrease in calculation accuracy. In particular, the adders 120 and 122, the D type flip flop 130 and the coefficient multiplier 132 which are capable of processing data whose bit number is larger than that of input data by 12 bits are required to be provided to perform the accumulating process (if the number of input data subjected to an accumulating process is 4K). This, however, less increases the circuit scale than the scale of the delay circuit 110.

Forming the delay circuit 110 using a semiconductor memory such as a RAM readily realizes a larger scale delay circuit.

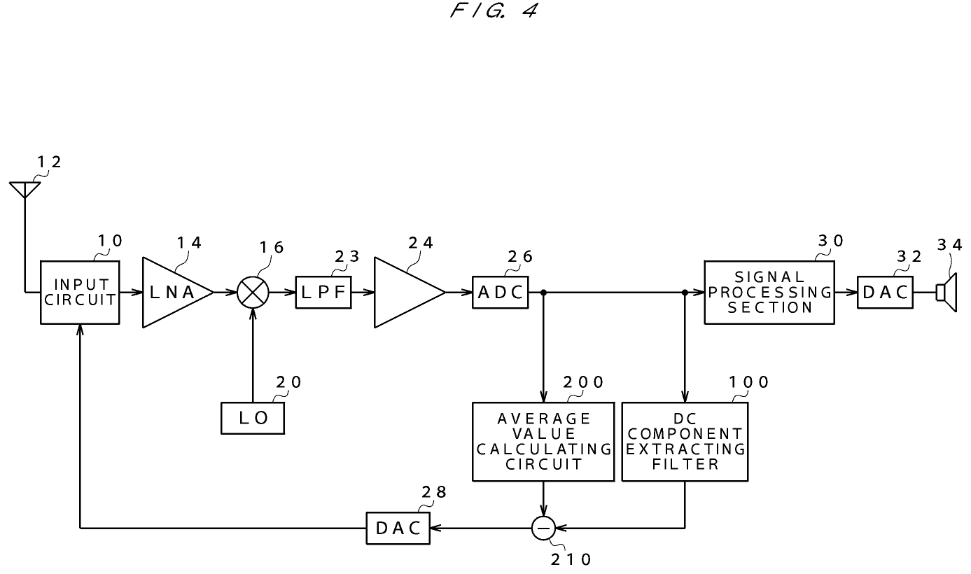

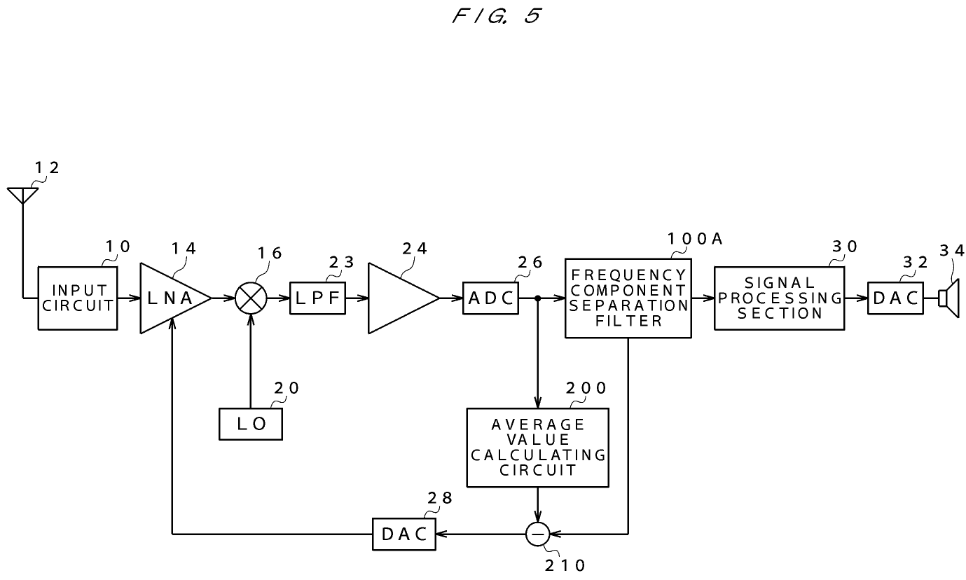

FIG. 4 is an example of a modification of the direct conversion receiver illustrated in FIG. 1. Although the control voltage used for automatic gain control is input to the low-noise amplifier 14 in the configuration illustrated in FIG. 1, the control voltage may be input to the input circuit 10 to perform the automatic gain control as illustrated in FIG. 4. The input circuit 10 includes a variable attenuation circuit using a PIN diode, so that attenuation (gain) in the variable attenuation circuit may be set according to the control voltage, for example.

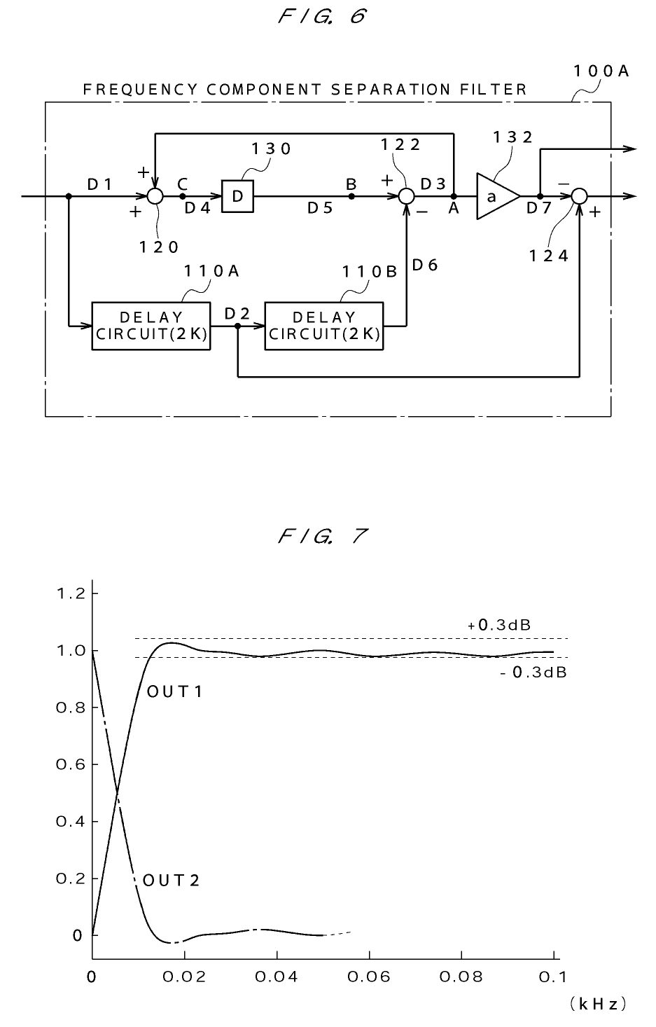

FIG. 5 is another example of a modification of the direct conversion receiver illustrated in FIG. 1. The configuration illustrated in FIG. 5 replaces the DC component extracting filter 100 illustrated in the configuration of FIG. 1 with a frequency component separation filter 100A and changes its connection form.

The frequency component separation filter 100A extracts DC components included in the baseband signal and outputs the baseband signal from which DC components have been removed based on digital data output from the analog-to-digital converter 26. This separates frequency components of less than 10 Hz from those of 10 Hz or higher, for example. One of the frequency components of less than 10 Hz is equivalent to the DC offset voltage extracted by the DC component extracting filter 100. Inputting the frequency components of less than 10 Hz to the subtractor 210 causes the low-noise amplifier 14 to perform the automatic gain control, as is the case with the configuration illustrated in FIG. 1. The other of the frequency components of 10 Hz or higher is a signal in which the DC offset voltage is removed from the baseband signal and is input to the signal processing section 30 at the rear stage.

The configuration of the frequency component separation filter 100A is described in detail below.

FIG. 6 is a block diagram illustrating the configuration of the frequency component separation filter 100A. The frequency component separation filter 100A illustrated in FIG. 6 includes two delay circuits 110A and 110B, three adders 120, 122 and 124, one D type flip flop 130 and one coefficient multiplier 132.

Incidentally, the frequency component separation filter 100A is similar in configuration to the DC component extracting filter 100 illustrated in FIG. 2. For better understanding, the basically common composing elements are designated by the same reference numerals and characters. A 16-bit digital data sampled with a sampling frequency “f” of, for example, 50 kHz (or, digital data output from the analog-to-digital converter 26) is input to the frequency component separation filter 10A.

The number of taps in one delay circuit 110A is set to 2K (=2048). The delay circuit 110A holds 2K 16-bit digital data D1 input to the frequency component separation filter 100A in the order of input and then outputs them. Similarly, the number of taps in the other delay circuit 110B is set to 2K. The delay circuit 110B holds 2K digital data D2 output from the one delay circuit 110A in the order of input and then outputs them. Since neither of the delay circuits 110A and 110B have intermediate taps, they may be realized by using a semiconductor memory such as a shift register or RAM.

The adder 120 adds data D1 input to the frequency component separation filter 100A to data D3 output from the adder 122 at the rear stage. The D type flip flop 130 holds data D4 as a calculation result output from the adder 120 for one clock, and then outputs it. The adder 122 outputs a result in which the data D6 output from the delay circuit 110B at the rear stage is subtracted from the data D5 held in the D type flip flop 130.

The coefficient multiplier 132 whose coefficient “a” is set to 1/(4K−1)=1/4095 outputs a result in which the data D3 output from the adder 122 is multiplied by a coefficient “a.” The adder 124 subtracts the data D7 output from the coefficient multiplier 132 from the data D2 output from the delay circuit 110A at the front stage.

The above delay circuits 110A and 110B, the adders 120 and 122, the D type flip flop 130 and the adder 124 correspond to a subtracting unit. The delay circuits 110A and 110B, the adders 120 and 122 and the D type flip flop 130 correspond to an accumulating unit. The coefficient multiplier 132 corresponds to a coefficient multiplying unit. The two delay circuits 110A and 110B, the adder 120, the adder 122 and the D type flip flop 130 correspond to a delay unit, a first adding unit, a second adding unit and a data holding unit, respectively.

The two delay circuits 110A and 110B and the D type flip flop 130 are reset when the frequency component separation filter 100A starts its operation. For this reason, after that, when the frequency component separation filter 100A starts its operation in synchronization with an operation clock, the data D5 (=D3) held in the D type flip flop 130 is input to the adder 120 through the adder 122 to be added to the input data D1 and accumulated till a first (4K+1) data D1 is input.

Subsequently, when the (4K+1) th data D1 is input and an accumulated value corresponding thereto is held in the D type flip flop 130, the delay circuit 110B outputs the first data D1 in synchronization with this timing. Accordingly, the adder 122 subtracts the first data from the value accumulated so far (or the accumulated value of the 4K input data D1) and outputs an accumulated value for 4K−1 (=N) from the second input data D1 to (4K+1) th input data. Thus, after that, the accumulating process is performed in such a manner that a (4K−1) input data D1 to be accumulated is shifted one by one every time a new data D1 is input. The accumulated data D3 is multiplied by “a” (=1/(4K−1)) by the coefficient multiplier 132 and then input to one input terminal of the adder 124.

The central data D2 of the (4K−1) input data D1 subjected to accumulation calculation is taken out from the delay circuit 110A in parallel with the above accumulating process. The data D2 is input to the other input terminal of the adder 124. The adder 124 outputs a result in which the data D7 output from the coefficient multiplier 132 is subtracted from the data D2.

Since the data D7 input to one input terminal of the adder 124 is such that a (4K−1) input data D1 is accumulated and then multiplied by “a” (=1/(4K−1)) to calculate a moving average, so that the (4K−1) input data D1 is smoothened, which means that lower frequency components (or DC components) of the input data D1 are extracted. Therefore, the subtraction of the lower frequency components from the data D2 in the adder 124 allows taking out only high frequency components in which DC components are removed as a second output. In addition, DC components extracted from the input data can be taken out from the coefficient multiplier 132 connected to one input terminal of the adder 124 as a first output.

FIG. 7 is a graph illustrating a result of simulating the frequency characteristic of the frequency component separation filter 100A. In FIG. 7, the abscissa and the ordinate represent frequency and amplitude value, respectively. As illustrated in FIG. 7, the use of the frequency component separation filter 100A of the present embodiment provides an output OUT1 in which DC components of 10 Hz to 20 Hz or lower are removed and an output OUT2 in which DC components of 10 Hz to 20 Hz or lower are extracted.

Thus, in the frequency component separation filter 100A, the calculation of moving average of the input data permits extracting lower frequency components (or DC components) included in the input data. The lower frequency components are subtracted from the input data to enable DC components included in the input data to be removed. This permits simultaneously taking out both DC components and the other frequency components included in the input data. In particular, performing only the moving average and subtraction eliminates the need for multiplying units (or steps) of the number of which corresponds to the number of objects subjected to the calculation of the moving average, enabling circuit scale to be reduced and processing contents to be simplified.

The above calculation of moving average is realized by accumulating the predetermined number N of input data and multiplying the accumulated value by a coefficient of 1/N. This prevents a rounding error caused by an accumulating process from being produced at the time of calculating the moving average and inhibits decrease in calculation accuracy. In particular, the adders 120 and 122, the D type flip flop 130 and the coefficient multiplier 132 which are capable of processing data whose bit number is larger than that of input data by 12 bits are required to be provided to perform the accumulating process (if the number of input data subjected to an accumulating process is 4K). This, however, less increases the circuit scale than the scale of the delay circuits 110A and 110B.

Forming the delay circuits 110A and 110B by using a semiconductor memory such as a RAM readily realizes a larger scale delay circuit.

In the configurations illustrated in FIGS. 2 and 6, although the DC component extracting filter 100 takes out the data D7 output from the coefficient multiplier 132 as DC components included in the input data, accumulated data or data equivalent thereto may be taken out from any of the output A of the adder 122 and the output B of the D type flip flop 130 illustrated in FIG. 2 to be input to the coefficient multiplier 132 instead of data output from the adder 122.

In the above embodiments, although the coefficient “a” of the coefficient multiplier 132 is set to 1/N to divide the accumulated value by the number N of data subjected to the accumulating process, the coefficient “a” may be set to one (1) or less and a value larger than 1/N. Setting the coefficient to one (1) or less and a value larger than 1/N enables DC components to be extracted and data to be amplified. Furthermore, if amplification is performed in a circuit at the rear stage, amplification is performed after lower bit information has lacked, however, if such a coefficient is set, data can be taken out before lower bit information lacks, thereby improving S/N ratio and dynamic range.

In the above embodiments, although the number N of data (=4K−1) subjected to the calculation of the moving average is set to an odd number, the number N is set to an even number and to the number of powers of 2 (N=2^{m}) to enable the coefficient multiplier 132 to be realized by a simple bit shift circuit, or more simply, to be realized by arranging wiring to shift a bit position from which data is taken out to the upper side. If N=4096=2¹², for example, data D7 may be taken out only from a signal line corresponding to the predetermined number of bits upper than the 13th bit counted from the lower bit without using a signal line of the lower 12 bits to perform a multiplying process of the coefficient “a”=½¹². This allows the configuration of the DC component extracting filter 100 without substantially using a coefficient multiplier.

In the configuration illustrated in FIG. 6, although the central data D2 in the (4K−1) data subjected to the calculation of the moving average is taken out to be input to the adder 124, the data D2 may be taken out from around the central instead of the central position. Theoretically, it is desirable to take out the central data D2 in the (4K−1) data to realize a linear phase characteristic, but practically, even if a position where the data D2 is taken out is shifted from the center, the frequency characteristic and phase characteristic can be practically maintained without significantly degrading the phase characteristic. Moreover, setting a difference between the number of data held by the delay circuit 110A at the front stage and the number of data held by the delay circuit 110B at the rear stage to one (1) or other odd numbers enables the total sum of the values to be made an odd number. In this case, since the value of N in the coefficient “a”=1/N of the coefficient multiplier 132 can be taken to be an even number, taking the value N to be the number of powers of 2 allows the coefficient multiplier 132 to be realized by a simple bit shift circuit or, more simply, to be realized by devising wiring to shift a bit position from which data is taken out to the upper side. If N=4096=2¹², for example, only a signal line corresponding to the predetermined number of bits upper than the 13th bit counted from the lower bit may be connected to one input terminal of the adder 124 without using a signal line of the lower 12 bits to perform a multiplying process of the coefficient “a”=½¹². This allows the configuration of the frequency component separation filter 100A without substantially using a coefficient multiplier.

### Second Embodiment

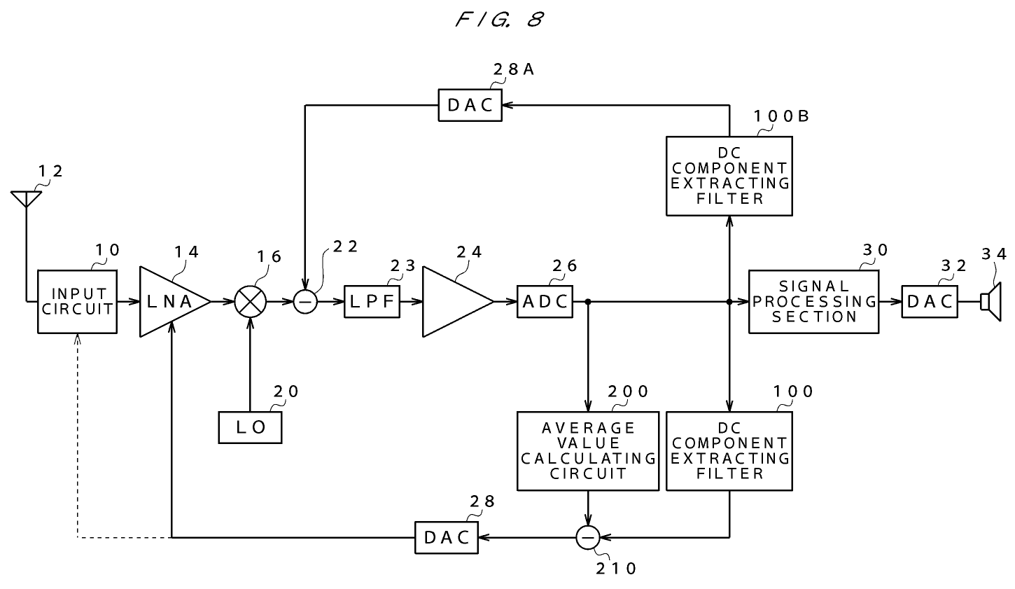

FIG. 8 is a block diagram illustrating the basic configuration of a direct conversion receiver of a second embodiment. The direct conversion receiver illustrated in FIG. 8 is different from the direct conversion receiver illustrated in FIG. 1 in that a DC component extracting filter 100B, a digital-to-analog converter (DAC) 28A and a subtractor 22 are added to the receiver. The other composing elements are common. In the direct conversion receiver of the present embodiment, as is the case with the first embodiment, almost all the components are integrally formed on a semiconductor substrate using MOS process or CMOS process, except the antenna 12, the speaker 34 and a small number of other components. The signal processing section 30, the DC component extracting filters 100 and 100B and the average value calculating circuit 200 may be realized by using a DSP, for example. The above DC component extracting filter 100B, the digital-to-analog converter 28A and the subtractor 22 correspond to a second DC component extracting filter, a second digital-to-analog converter and a second subtractor 22, respectively.

The DC component extracting filter 100B extracts the DC offset voltage (digital data) being the DC components included in the baseband signal based on the digital data output from the analog-to-digital converter 26. The DC component extracting filter 100B is the same in basic configuration as the DC component extracting filter 100 illustrated in FIG. 2. A detailed description of the configuration and the operation thereof is omitted. The output of the DC component extracting filter 100B is converted to an analog voltage by the digital-to-analog converter 28A.

The subtractor 22 is interposed between the mixer 16 and the lowpass filter 23. The subtractor 22 subtracts the output voltage of the digital-to-analog converter 28A from the baseband signal output from the mixer 16 to remove the DC offset voltage included in the baseband signal. The baseband signal output from the baseband amplifier 24 includes DC components generated by the local oscillation signal leaking into the input side of the received signal in the mixer and DC components as an offset voltage generated in the baseband amplifier 24. The DC component extracting filter 100B extracts the DC components of 10 Hz or lower and outputs data corresponding to the voltage level of the DC components. The data is converted to the DC offset voltage by the digital-to-analog converter 28A and input to the subtractor 22. The subtractor 22 subtracts (or removes) the DC offset voltage output by the digital-to-analog converter 28A from the baseband signal output from the mixer 16 to output it.

Thus, in the direct conversion receiver of the present embodiment, the use of the DC component extracting filter 100B capable of extracting the DC components of 10 Hz or lower enables extracting and removing the DC offset voltage included in the baseband signal corresponding to a continuously received signal. In addition, the DC component extracting filter 100 is used to correctly detect the level of the continuously received career signal to make variable the amplification factor of the low-noise amplifier 14, enabling the automatic gain control.

As indicated by the dotted line in FIG. 8, the output voltage of the digital-to-analog converter 28 may be input to the input circuit 10 to perform automatic gain control. In this case, the input circuit 10 operates in the same manner as described in the first embodiment in FIG. 4.

In the present embodiment, although the subtractor 22 is interposed between the mixer 16 and the lowpass filter 23, the subtractor 22 may be interposed between the lowpass filter 23 and the baseband amplifier 24 instead.

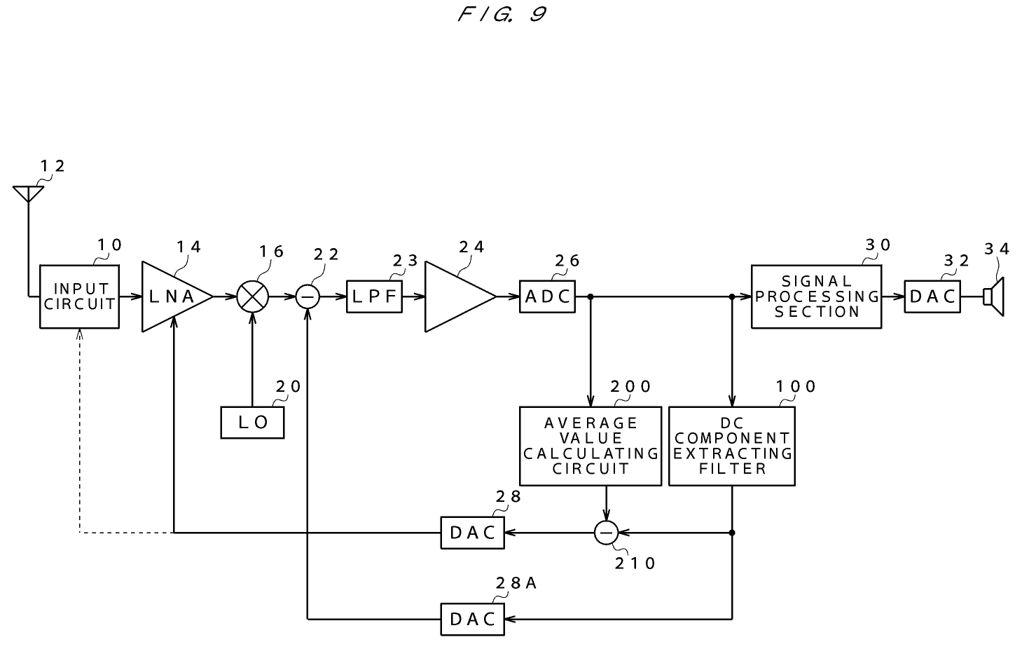

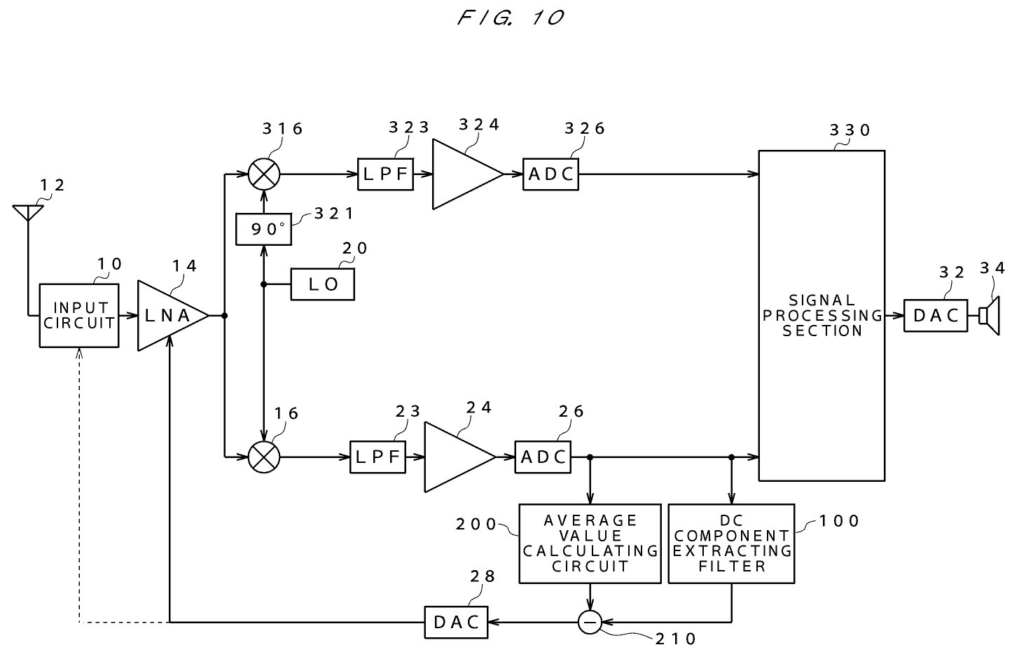

In the present embodiment, the two DC component extracting filters 100 and 100B are used to extract DC components included in the baseband signal, so that any one of the two DC component extracting filters 100 and 100B may be omitted. For example, as illustrated in FIG. 9, the DC component extracting filter 100B is omitted and the output of the DC component extracting filter 100 may be input to the digital-to-analog converter 28A.

### Third Embodiment

The foregoing first and the second embodiment describe the basic operation in which the offset voltage included in the baseband voltage is extracted to remove the offset voltage and the automatic gain control of the low-noise amplifier 14 is performed, however, a practical direct conversion receiver needs to perform orthogonal modulation to separate an in-phase component (I signal) from an orthogonal component (Q signal).

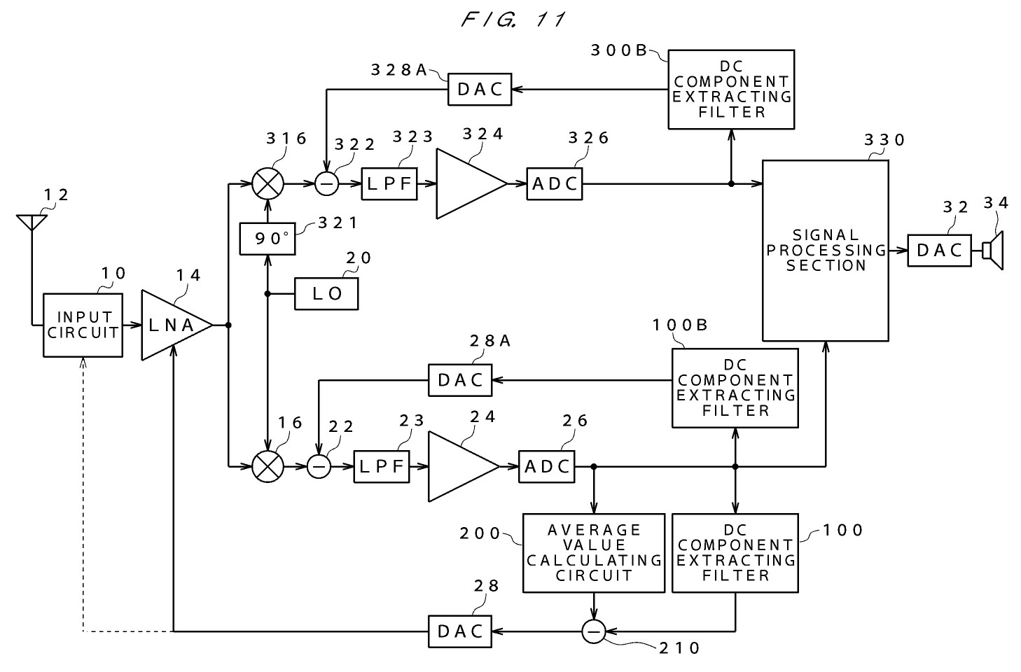

FIG. 10 is a block diagram illustrating the configuration of the direct conversion receiver of the third embodiment in which an orthogonal modulation function is added to the configuration in FIG. 1. The direct conversion receiver illustrated in FIG. 10 is different from the direct conversion receiver illustrated in FIG. 1 in that a mixer 316, a phase shifter 321, a lowpass filter 323, a baseband amplifier 324, and an analog-to-digital converter 326 are added and the signal processing section 30 is replaced with a signal processing section 330.

The local oscillation signal output from the local oscillator 20 is passed through the phase shifter 321 to have its phase shifted by 90° and is output. The local oscillation signal whose phase is shifted is input to the mixer 316. This generates the baseband signal whose phase is shifted by 90° with respect to the baseband signal (I signal) output from the mixer 16.

The lowpass filter 323 removes frequency components higher than the required frequency band included in the baseband signal output from the mixer 316. The baseband amplifier 324 amplifies the baseband signal input through the lowpass filter 323. The analog-to-digital converter 326 samples the baseband signal amplified and output by the baseband amplifier 324 with a predetermined frequency to convert it to digital data. The signal processing section 330 performs signal processing such as demodulation using the I and Q signals converted to digital data to generate voice data.

In the direct conversion receiver illustrated in FIG. 10, although the DC component extracting filter 100 and the average value calculating circuit 200 are connected to a system for processing the I signal, the DC component extracting filter 100 and the average value calculating circuit 200 may be connected to a system for processing the Q signal. In addition, as indicated by the dotted line in FIG. 10, the output voltage of the digital-to-analog converter 28 may be input to the input circuit 10 to perform the automatic gain control.

FIG. 11 is a block diagram illustrating the configuration of the direct conversion receiver in which an orthogonal modulation function is added to the configuration in FIG. 8. The direct conversion receiver illustrated in FIG. 11 is different from the direct conversion receiver illustrated in FIG. 8 in that the mixer 316, the phase shifter 321, a subtractor 322, the baseband amplifier 324, the analog-to-digital converter 326, a DC component extracting filter 300B and DAC 328A are added and the signal processing section 30 is replaced with a signal processing section 330. The composing elements having the same functions as those in FIG. 10 are designated by the same reference numerals and characters.

In the direct conversion receiver illustrated in FIG. 11, although the DC component extracting filter 100 and the average value calculating circuit 200 are connected to a system for processing the I signal, the DC component extracting filter 100 and the average value calculating circuit 200 may be connected to a system for processing the Q signal. In addition, as indicated by the dotted line in FIG. 11, the output voltage of the digital-to-analog converter 28 may be input to the input circuit 10 to perform automatic gain control. The subtractor 22 may be connected between the lowpass filter 23 and the baseband amplifier 24. The subtractor 322 may be connected between the lowpass filter 323 and the baseband amplifier 324.

### INDUSTRIAL APPLICABILITY

According to the present invention, the DC component extracting filter calculates the moving average of the input data to enable lower frequency components (or DC components) included in the input data to be extracted. Furthermore, multiplying units of the number of which corresponds to the number of objects subjected to the calculation of the moving average are not required, which allows circuit scale to be reduced and processing contents to be simplified. In particular, accumulating N input data and then multiplying the accumulated N data by a predetermined coefficient of 1/N prevent a rounding error caused by an accumulating process from being produced at the time of calculating the moving average and inhibits decrease in calculation accuracy. Setting the coefficient to one (1) or less and a value larger than 1/N enables DC components to be extracted and data to be amplified. Furthermore, if amplification is performed in a circuit at the rear stage, amplification is performed after lower bit information has lacked however, in the present invention, data can be taken out before lower bit information lacks, so that S/N ratio and dynamic range can be improved. The DC offset voltage included in the baseband signal is extracted by such a DC component extracting filter and subtracted from the average value of the baseband signal, thereby enabling correctly detecting the signal level of the carrier to allow the automatic gain control for continuously received signals. Using the DC component extracting filter permits extracting the DC offset voltages included in the baseband signal corresponding to continuously received signals and removing them.

1. A direct conversion receiver characterized by comprising:
a first amplifier to which a signal received through an antenna is input and which amplifies the signal with a gain according to a control voltage;
a local oscillator which generates a local oscillation signal having the same frequency as a signal desired to be received;
a mixer which mixes the signal amplified by the first amplifier with the local oscillation signal to generate a baseband signal;
a second amplifier which amplifies the baseband signal output from the mixer;
an analog-to-digital converter which converts the signal amplified by the second amplifier to digital data;
a first DC component extracting filter which extracts a DC component as a DC offset voltage included in the baseband signal based on data output from the analog-to-digital converter;
an average value calculating circuit which calculates average value of the data output from the analog-to-digital converter;
a first subtractor which subtracts the DC component extracted by the first DC component extracting filter from the average value calculated by the average value calculating circuit; and
a first digital-to-analog converter which converts data subjected to subtraction in the first subtractor to the control voltage of analog; wherein
the first DC component extracting filter includes an accumulating unit which accumulates the value of the predetermined number N of input data and a coefficient multiplying unit which multiplies the value accumulated by the accumulating unit by a coefficient of 1/N or a coefficient which is one (1) or less and larger than 1/N.

2. The direct conversion receiver according to claim 1, wherein
the accumulating unit includes:
a delay unit which holds the (N+1) input data in the order of input and outputs them;
a first adding unit which adds an accumulated value to the input data;
a data holding unit which holds a result of addition by the first adding unit for a time period corresponding to an input interval of the input data and outputs it; and
a second adding unit which outputs a result of subtracting output data of the delay unit from data output from the data holding unit both to the first adding unit and to the coefficient multiplying unit as the accumulated value.

3. The direct conversion receiver according to claim 2, wherein
the output of any of the first adding unit and the data holding unit is input to the coefficient multiplying unit.

4. The direct conversion receiver according to claim 2, wherein
the delay unit is formed of a semiconductor memory.

5. The direct conversion receiver according to claim 1, wherein
the coefficient of the coefficient multiplying unit is represented by ½^{m}, where, “m” is an integer of one (1) or more, and the coefficient multiplying unit shifts bit position to perform multiplication with ½^{m} as the coefficient.

6. A direct conversion receiver characterized by comprising:
a first amplifier which amplifies a signal received through an antenna;
an input circuit which is provided between the antenna and the first amplifier and has a gain corresponding to a control voltage;
a local oscillator which generates a local oscillation signal having the same frequency as a signal desired to be received;
a mixer which mixes the signal amplified by the first amplifier with the local oscillation signal to generate a baseband signal;
a second amplifier which amplifies the baseband signal output from the mixer;
an analog-to-digital converter which converts the signal amplified by the second amplifier to digital data;
a first DC component extracting filter which extracts a DC component as a DC offset voltage included in the baseband signal based on data output from the analog-to-digital converter;
an average value calculating circuit which calculates average value of the data output from the analog-to-digital converter;
a first subtractor which subtracts the DC component extracted by the first DC component extracting filter from the average value calculated by the average value calculating circuit; and
a first digital-to-analog converter which converts data subjected to subtraction in the first subtractor to the control voltage of analog; wherein
the first DC component extracting filter includes an accumulating unit which accumulates the value of the predetermined number N of input data and a coefficient multiplying unit which multiplies the value accumulated by the accumulating unit by a coefficient of 1/N or a coefficient which is one (1) or less and larger than 1/N.

7. The direct conversion receiver according to claim 6, wherein
the accumulating unit includes:
a delay unit which holds the (N+1) input data in the order of input and outputs them;
a first adding unit which adds an accumulated value to the input data;
a data holding unit which holds a result of addition by the first adding unit for a time period corresponding to an input interval of the input data and outputs it; and
a second adding unit which outputs a result of subtracting output data of the delay unit from data output from the data holding unit both to the first adding unit and to the coefficient multiplying unit as the accumulated value.

8. The direct conversion receiver according to claim 7, wherein
the output of any of the first adding unit and the data holding unit is input to the coefficient multiplying unit.

9. The direct conversion receiver according to claim 7, wherein
the delay unit is formed of a semiconductor memory.

10. The direct conversion receiver according to claim 6, the coefficient of the coefficient multiplying unit is represented by ½^{m}, where, “m” is an integer of one (1) or more, and the coefficient multiplying unit shifts bit position to perform multiplication with ½^{m} as the coefficient.

11. A direct conversion receiver characterized by comprising:
a first amplifier to which a signal received through an antenna is input and which amplifies the signal with a gain according to a control voltage;
a local oscillator which generates a local oscillation signal having the same frequency as a signal desired to be received;
a mixer which mixes the signal amplified by the first amplifier with the local oscillation signal to generate a baseband signal;
a second amplifier which amplifies the baseband signal output from the mixer;
an analog-to-digital converter which converts the signal amplified by the second amplifier to digital data;
a first and a second DC component extracting filters which extract a DC component as a DC offset voltage included in the baseband signal based on data output from the analog-to-digital converter;
an average value calculating circuit which calculates average value of the data output from the analog-to-digital converter;
a first subtractor which subtracts the DC component extracted by the first DC component extracting filter from the average value calculated by the average value calculating circuit;
a first digital-to-analog converter which converts data subjected to subtraction in the first subtractor to the control voltage of analog;
a second digital-to-analog converter which converts data corresponding to a DC component extracted by the second DC component extracting filter to an analog voltage; and
a second subtractor which subtracts output voltage of the second digital-to-analog converter from the baseband signal output from the mixer to remove the DC offset voltage included in the baseband signal; wherein
the first and the second DC component extracting filters include an accumulating unit which accumulates the value of the predetermined number N of input data and a coefficient multiplying unit which multiplies the value accumulated by the accumulating unit by a coefficient of 1/N or a coefficient which is one (1) or less and larger than 1/N.

12. The direct conversion receiver according to claim 11, wherein
the accumulating unit includes:
a delay unit which holds the (N+1) input data in the order of input and outputs them;
a first adding unit which adds an accumulated value to the input data;
a data holding unit which holds a result of addition by the first adding unit for a time period corresponding to an input interval of the input data and outputs it; and
a second adding unit which outputs a result of subtracting the output data of the delay unit from the data output from the data holding unit both to the first adding unit and to the coefficient multiplying unit as the accumulated value.

13. The direct conversion receiver according to claim 12, wherein
the output of any of the first adding unit and the data holding unit is input to the coefficient multiplying unit.

14. The direct conversion receiver according to claim 12, wherein
the delay unit is formed of a semiconductor memory.

15. The direct conversion receiver according to claim 11, wherein
the coefficient of the coefficient multiplying unit is represented by ½^{m}, where, “m” is an integer of one (1) or more, and the coefficient multiplying unit shifts bit position to perform multiplication with ½^{m} as the coefficient.

16. The direct conversion receiver according to claim 11, wherein
either one of the first and the second DC component extracting filter is omitted and the output of the other is input to the first subtractor and the second digital-to-analog converter.

17. A direct conversion receiver characterized by comprising:
a first amplifier which amplifies a signal received through an antenna;
an input circuit which is provided between the antenna and the first amplifier and has a gain corresponding to a control voltage;
a local oscillator which generates a local oscillation signal having the same frequency as a signal desired to be received;
a mixer which mixes the signal amplified by the first amplifier with the local oscillation signal to generate a baseband signal;
a second amplifier which amplifies the baseband signal output from the mixer;
an analog-to-digital converter which converts the signal amplified by the second amplifier to digital data;
a first and a second DC component extracting filters which extract a DC component as a DC offset voltage included in the baseband signal based on data output from the analog-to-digital converter;
an average value calculating circuit which calculates average value of the data output from the analog-to-digital converter;
a first subtractor which subtracts the DC component extracted by the first DC component extracting filter from the average value calculated by the average value calculating circuit;
a first digital-to-analog converter which converts data subjected to subtraction in the first subtractor to the control voltage of analog;
a second digital-to-analog converter which converts data corresponding to a DC component extracted by the second DC component extracting filter to an analog voltage; and
a second subtractor which subtracts output voltage of the second digital-to-analog converter from the baseband signal output from the mixer to remove the DC offset voltage included in the baseband signal; wherein
the first and the second DC component extracting filters include an accumulating unit which accumulates the value of the predetermined number N of input data and a coefficient multiplying unit which multiplies the value accumulated by the accumulating unit by a coefficient of 1/N or a coefficient which is one (1) or less and larger than 1/N.

18. The direct conversion receiver according to claim 17, wherein
the accumulating unit includes:
a delay unit which holds the (N+1) input data in the order of input and outputs them;
a first adding unit which adds an accumulated value to the input data;
a data holding unit which holds a result of addition by the first adding unit for a time period corresponding to an input interval of the input data and outputs it; and
a second adding unit which outputs a result of subtracting output data of the delay unit from data output from the data holding unit both to the first adding unit and to the coefficient multiplying unit as the accumulated value.

19. The direct conversion receiver according to claim 18, wherein
the output of any of the first adding unit and the data holding unit is input to the coefficient multiplying unit.

20. The direct conversion receiver according to claim 18, wherein
the delay unit is formed of a semiconductor memory.

21. The direct conversion receiver according to claim 17,
the coefficient of the coefficient multiplying unit is represented by ½^{m}, where, “m” is an integer of one (1) or more, and the coefficient multiplying unit shifts bit position to perform multiplication with ½^{m} as the coefficient.

22. The direct conversion receiver according to claim 17, wherein
either one of the first and the second DC component extracting filter is omitted and the output of the other is input to the first subtractor and the second digital-to-analog converter.
